(19) United States
(12) Patent Application Publication
(10) Pub. No.: US 2007/0196028 A1
(43) Pub. Date: Aug. 23, 2007

(54) Multi-Purpose Digital Image Editing Tools Using Background Processing

(75) Inventors: Nils Kokemohr, Hamburg (DE); Manuel Wille, Lubeck (DE)

Correspondence Address: NIK SOFTWARE, INC.;c/o SHELDON MAK ROSE & ANDERSON, 100 EAST CORSON STREET, THIRD FLOOR, PASADENA, CA, 91103-3842, US

(73) Assignee: NIK SOFTWARE, INC., San Diego, CA (US)

(21) Appl. No.: 11/678,025

(22) Filed: Feb. 22, 2007

Related U.S. Application Data
(60) Provisional application No. 60/776,140, filed on Feb. 22, 2006.
(60) Provisional application No. 60/776,557, filed on Feb. 23, 2006.

(51) Int. Cl. G06K 9/40

(52) U.S. Cl. 382/254

(57) ABSTRACT

A multi-purpose digital editing tool with background processing which permits different enhancements from a single tool, or multiple tools from a single enhancement. The user may exchange enhancements while preserving an applied tool, or exchange the tool while preserving an applied enhancement. The user may select a first area in a preview and assign a first enhancement to that user-selected area, and then have the option to select a second area in the preview, or assign a second enhancement. The first enhancement may be voided when a second enhancement is assigned. Similarly, the first area selection may be voided when a second area is selected.

### CROSS-REFERENCE TO RELATED APPLICATIONS

The present Application claims the benefit of U.S. Provisional Patent Application No. 60/776,140 titled “Multi-Purpose Digital Editing Tools“filed February 22, 2006, and U.S. Provisional Patent Application No. 60/776,557 titled “Background Processing for Digital Editing” filed Feb. 23, 2006, and the contents of which are incorporated by reference in this disclosure in their entirety.

### BACKGROUND OF THE INVENTION

The invention described herein relates to a new multi-purpose tool for editing digital images, which in a preferred embodiment uses background processing of image data.

In current image editing applications, tools and enhancements are often provided as one-tool-for-one-purpose solution. Some examples are:
Photoshop® Standard brush (paints a color into the image)
Photoshop° Blur brush (blurs the image where the user is brushing)
Photoshop® Sharpening Brush (sharpens where the user is brushing)
The Graduated Coffee filter from Nik Color Efex® (applies a gradient of a color)
The graduated fog filter (applies a gradient of a blur effect)
Photoshop® Fill color Enhancement
Photoshop® Blur Image Enhancement
Photoshop® Sharpen Image Enhancement

All these tools have one thing in common: they apply one of three filters (blurring, sharpening, or colorize) to either the full image, to a brush stroke or to a gradient. Considering that some image editing applications feature also other special brushes (for instance a darkening brush, a brightening brush, a saturation-decrease brush, etc.) it becomes obvious that image editing applications require a very complex user interface (UI) in order to provide a large functionality to the user. What is needed is a multi-purpose tool simplifies the user interface, and allows use of different enhancements from a single tool, or multiple tools from a single enhancement. The user should be able to exchange enhancements (e.g., colorize vs. blur) while preserving an applied tool, or exchange the tool (e.g., gradient vs. brush) while preserving an applied enhancement.

In an image processing application image data comes in several versions. First of course, the original, un-scaled, unmodified version is kept in memory. We call this version the model. On the other hand, several views of this model are available, such as e.g., the main view of the image and a thumbnail image. Principally, the views are downscaled (or otherwise simplified) versions of the input image. Therefore, they demand less memory than the model.

The user edits the image, which will be called filtering from now on. Naturally he or she wishes to see any filtering results promptly, but this applies only to the views, since they make up the contents of the display. The model data comes into play only when transferring the filtered data out of the application, as e.g., to a file on disk or to a printer. Processors in modern desktop computers invariably offer multitasking and multithreading. Therefore, it would be desirable to process the model data independently in a separate, low-priority thread. Preferably, large amounts of image data, irrelevant for the appearance of the desktop at that moment, would be processed in the background.

It would therefore be desirable to implement a multi-purpose tool using background processing.

### SUMMARY

The present invention meets this need by providing a method for applying enhancements to a digital image, comprising the steps of receiving the image at a first resolution; displaying a preview of the image to a user; allowing the user to select a first area in the preview; allowing the user to assign a first enhancement to the user-selected area; filtering a subset of pixels of the image at the first resolution; blending the filtered subset into the image using a mask derived from the user-selected area; displaying a preview of the image with a blended-in enhanced area; and providing the user with options to select a second area in the preview, or assign a second enhancement, and repeating the filtering, blending and displaying steps if any option is exercised. A further option to expand, modify or shrink a user-selected area may be provided.

Optionally, the preview is at a second resolution. The subset of pixels may be a sub-sampling of the image, or contain those pixels in the neighborhood of the user-selected area. The first enhancement may be voided when a second enhancement is assigned. Similarly, the first area selection may be voided when a second area is selected.

Background processing may be used so that a first processing thread is used to process the subset of pixels, and using a second processing thread to process additional pixels of the image.

A method for applying enhancements to a digital image is disclosed, comprising the steps of receiving the image at a first resolution; recording a series of first enhancements to the image received from the user, into an edit list; using a first processing thread to display a preview of the result of the enhancement series, processing a subset of the pixels in the image; recording a series of second, or modified first, enhancements to the image received from the user, into the edit list; reprocessing the subset of the pixels with the second, or modified first, enhancements; and processing the image at a final resolution using the full edit list.

A method for enhancing images based on a multi-threading system is disclosed, enabling a user to enhance an image in a trial-and-error workflow, comprising the steps of allowing the user to define a series of enhancements; allowing the user to assign regions of interest to one or more of said enhancements; providing a preview to the user based on a subset of pixels processed by a first processing thread; using, in parallel to the first thread, a second thread for processing a larger amount of pixels; allowing the user to make a decision based on said preview whether or not to retain the current set of enhancements and regions-of-interest; and allowing the user, based on said decision, to do one or more of the following trial-and-error modifications: remove one or more enhancements from the list; change the enhancements associated with a certain region-of-interest; modify one or more of the regions of interest; remove enhancements from said series of enhancements which no longer contribute to the result after the user has performed said trial-and-error modifications resulting in a simplification of said enhancements; and ensuring that any simplification of the series of enhancements is communicated to the second processing thread.

A computer readable medium having contents for causing a computer-based information handling system to perform the steps of the various methods is provided.

### BRIEF DESCRIPTION OF THE DRAWINGS

These and other features, aspects and advantages of the present invention will become better understood with regard to the following description, appended claims, and accompanying figures.

FIG. 1 is a flowchart of a filtering process in an individual thread useable in background processing for use in the invention.

FIG. 2 is a flowchart showing the top-level view of background processing.

FIG. 3 is a flowchart showing the main thread which establishes the connection between the user interface and the image processing threads in a background process.

FIG. 4 is a flowchart of one embodiment of the method of the invention.

FIG. 5 demonstrates a suitable user interface for a multi-purpose tool according to the invention.

FIG. 6 shows the manner in which bitmaps are processed in one embodiment of the invention.

FIG. 7.1 through 7.5 are depictions of the user interface as a user steps through use of a multi-purpose tool using one embodiment of the invention.

### DETAILED DESCRIPTION

The Multi-Purpose Tool (M-times-N) Workflow

The concept of a multi-purpose tool is to provide to the user a set of M tools (“tools” can be understood as mask creation or mask modification methods, for instance: brush, gradient, and fill entire image) and a set of N enhancements (“enhancements” are defined as those elements of an image editing application that perform one enhancement to the image, actually changing pixel data, for instance: blur, sharpen, colorize. Typically, the enhancement that is presented to the user is internally represented by one sub-filter Fₙ.) Conveniently, this can be referred to as “M-times-N” indicating that M number of tools can be interchangeably applied N number of ways.

When the user then selects a tool, for instance the brush, the software automatically allows the user to brush into the image using a default enhancement, for instance the colorize enhancement. If the user prefers to brush in a blurring effect, he can exchange the colorize enhancement with a blurring enhancement without quitting the brushing mode.

Likewise, when a user selects an enhancement, for instance sharpening, the sharpening effect is applied with the tool “apply to full image.” If the user prefers selective sharpening, he can - while the sharpening filter dialogue is open and active—use the brush to make a selective application.

Plus and Minus Tools

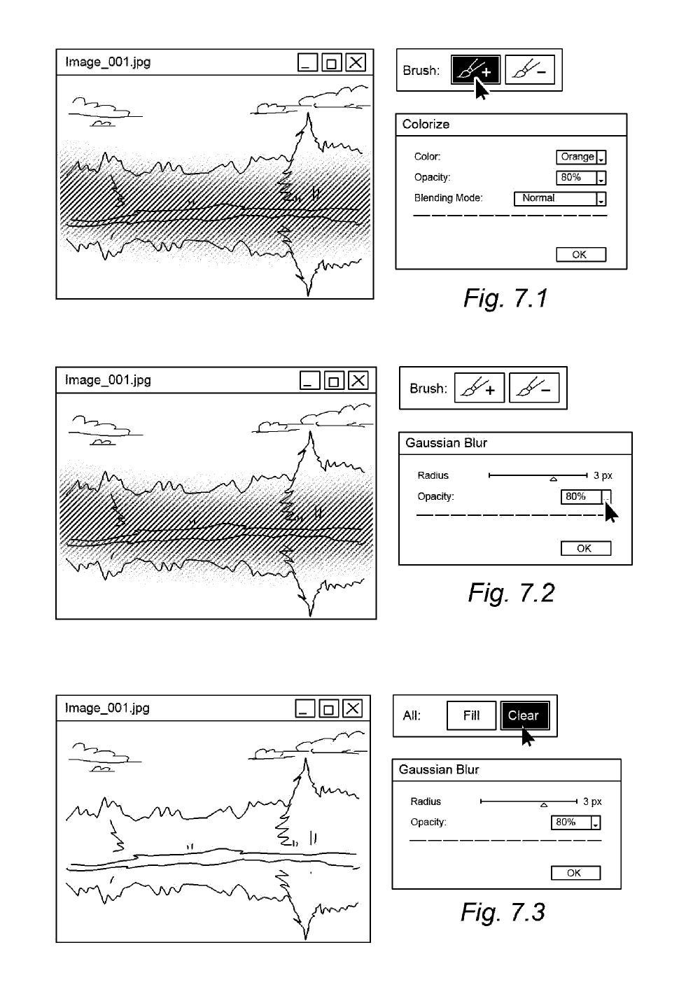

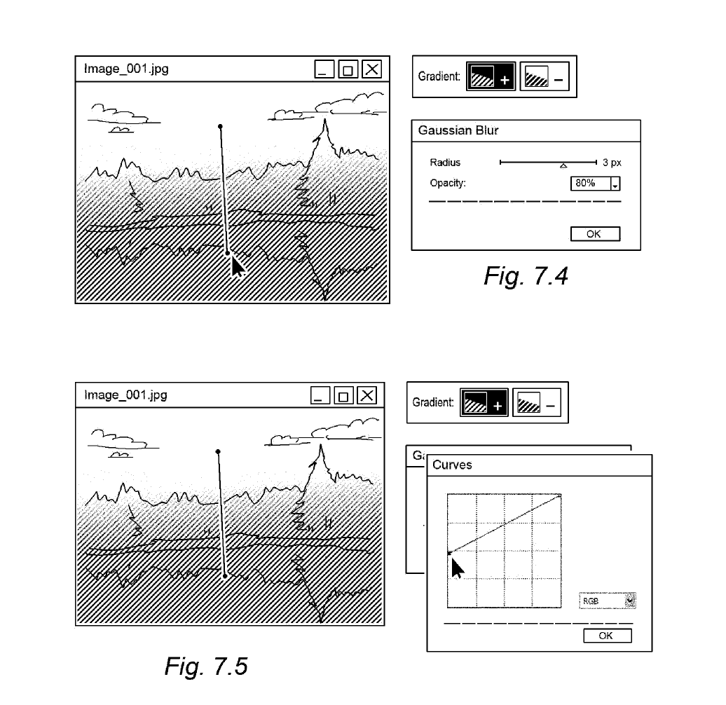

One further refinement of this concept is to provide all tools to the user as plus and minus tools. For instance, as shown in FIGS. 7.1 through 7.5, this might comprise a plus brush, a minus brush, a plus gradient, a minus gradient, a plus fill entire image and a minus fill entire image, the latter two better called “fill entire image” and “clear entire image.” The plus brush brushes in an enhancement, the minus brush reduces the enhancement, same for gradients, while the fill entire image tools fills the image and the clear image tool does the opposite.

An Illustrated Workflow

This will be clearer by examining FIGS. 7.1 through 7.5, which show a set of windows from an application that features one embodiment of the M-times-N concept. The top right element in each figure represents tools that the user can use (brush, gradient, fill image), here provided as plus and minus tools. In another embodiment (not shown) a lasso could be used. The bottom right element displays the enhancement currently used.

In FIG. 7.1 the user has clicked on the plus brush and has performed a brush stroke over the mountain, shown here with optional feathered edge. The intention of the user is to take some clarity out of this image and to add maybe a little fog to the mountain. (He doesn't exactly know how to achieve this, therefore this workflow includes trial-and-error steps.) The user likes the size and the placement of the brush stroke. The initial enhancement is “colorize,” and thus the brush stroke appears in orange (which appears in the black & white figure as the shaded area).

As noted, the user doesn't want to color the mountain, so in FIG. 7.2 the user has exchanged the enhancement “colorize” with the enhancement “Gaussian Blur” (the brush stroke selection has not changed). The application provides direct functionality for such an exchange. (That is, simple selection from the menu exchanges the effect. Also, in an edit list the current effect is graphically displayed and can be changed to a different effect with the concept known as pop up menu.) Note that the window to the right now shows different adjustments. The area of the image under the brush stroke now shows a blurred mountain (here indicated on the black & white figure by shading). The user can now refine the affected area using other brush stokes (including minus brush strokes to shrink the affected area), or he can tweak the strength of the blurring effect.

In FIG. 7.3 the user has changed his mind and clicks on the “Clear” (essentially, a “minus fill image”) tool in order to remove all brush stokes. Note that the blur dialog is still open and active.

In FIG. 7.4 the user has positioned a plus gradient into the image. This lets the foreground (the lower half) of the image become blurred (again, indicated on the black & white figure by progressive shading). Note: The tools do not need to be provided as plus and minus tools for M-times-N to work effectively. However, the concept of plus and minus allows for more convenience, for instance when combining gradients with brushes.

In FIG. 7.5 the user has added (using a special UI feature of this application) a second enhancement, so that the gradient is now used with two enhancements simultaneously—the Gaussian Blur and a Curves command. This allows the user to create a grayish, blurry fog effect in the foreground.

Conclusion of this workflow: The user has tried a number of different effects until he liked the result. He has exchanged the enhancements while preserving the applied tool, and respectively he has exchanged the tool (gradient vs. brush) while preserving the applied enhancement. While experimenting, he didn't need to make any re-adjustments in any enhancement dialogue window. Also, no knowledge about masks was necessary.

Implementation of the Multi-Purpose Tool

If implemented in an application laid out like Photoshop®, the following steps would need to be processed when, for instance, the user clicks on the plus brush, which is at a certain point associated with the blur effect: user clicks plus brush, application needs to duplicate the image in memory, application needs to apply the blur effect onto that duplicated bitmap, application needs to create an empty mask, and user can start to brush.

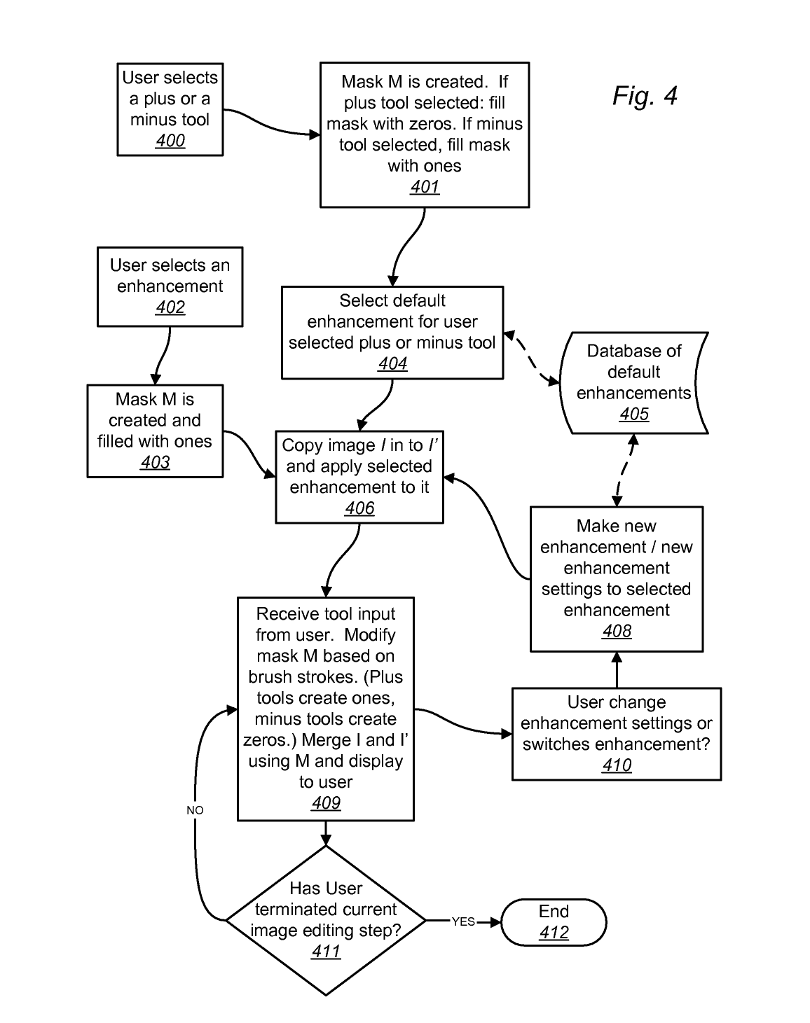

With reference to FIG. 4, the user selects 400 a initial tool, in the shown embodiment being a plus or a minus tool. A mask M is created 401. If the plus tool has been selected, the mask is filled with zeros. If a minus tool is selected, the mask is filled with ones. A default enhancement is selected 404 for the user selected plus or minus tool, using data from the database 405 of default enhancements. Optionally, the user has also selected 402 an initial enhancement, in which case a mask is created 403 and filled with ones. In either case, the image I is copied into I′ and the selected enhancement is applied 406.

If the user changes the tool, then the new tool is received 409, the mask is modified based on the new tool, and the image I is merged with I′ using the mask M and displayed. If the user changes the enhancement settings or switches enhancement 410, the new settings are applied 408, and the image I is copied into I′ and the new enhancement is applied 406.

The method allows for continual substitution of either tools or enhancements, until the user terminates the image editing step 411, and the method ends 412.

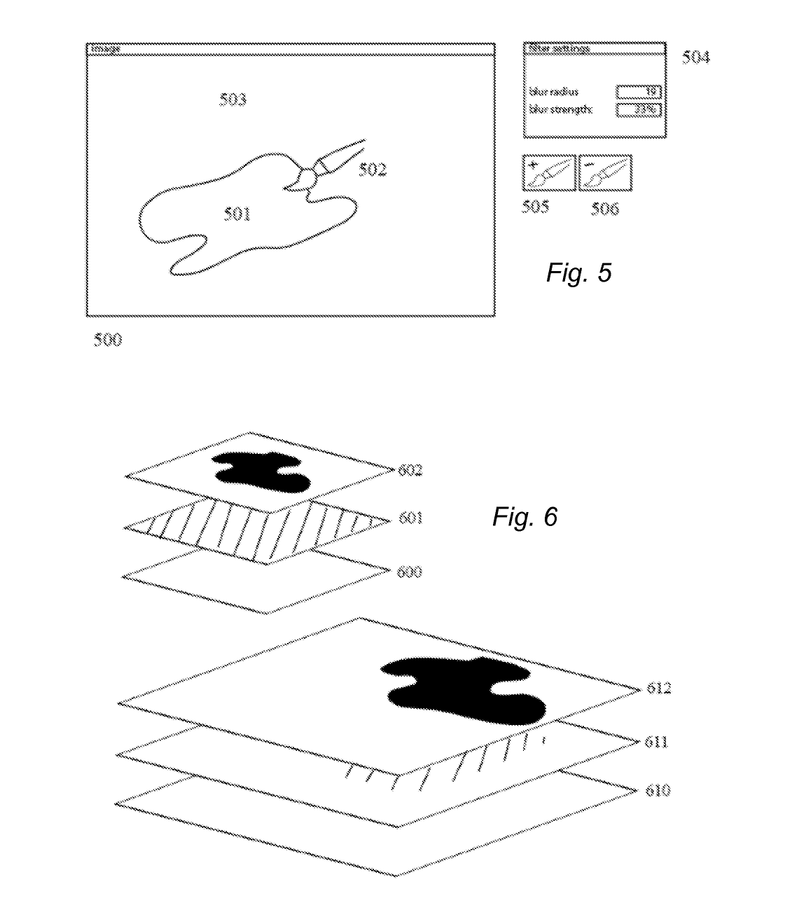

FIG. 6 represents the bitmaps in the processing used. With reference also to FIG. 5 which shows one embodiment of a user interface, bitmap 600 contains the image portion 503 that is displayed in the window 500, before applying any added enhancements. Bitmap 601 is a copy of bitmap 600, onto which the current enhancement 504 has been applied. If sufficient processing power is available, the entire bitmap 601 should be processed. If that is not the case, it may be advisable to first calculate an area within 601 that is spatially centered around the mouse cursor location, before, while or after brushing. However, in most cases, since the bitmap 601 has low dimensions, it will be often possible to filter the entire bitmap 601. Mask 602 contains the brush stroke from the user. Note that the bitmaps 602, 601 and 600 have only small dimensions, as they belong to one of the preview threads Hₗ.

Bitmap 610 is the full resolution version of the image, being processed by the thread Ho. The enhancement(s) that the user is applying to the image are not applied to this bitmap. Bitmap 611 is a copy of the bitmap 610, to which the enhancement was applied at actual, final resolution. Note, though, that the enhancement needs not be applied to the full image dimensions, illustrated here by a lined area smaller than the full image size. (Of course, memory for the bitmap 611 need not be allocated regarding those areas where the enhancement is not applied). Bitmap 612 is the full resolution version of the mask.

The preview image that the user sees on the screen is repeatedly created by merging 600, 601 and 602. This merging is part of one of the preview filter threads Hₗ with l not equal zero. The image that is used for actual, hi-res data (saving and printing) is calculated using bitmaps 610, 611 and 612. Since the processing of bitmaps 612 and 611 may take place after the user has finished brushing, it is easy to identify areas in 611 and 612 that need not be processed.

This is of course very processing intense, considering that images from digital cameras are typically much larger than monitor resolutions. Particularly, the user would have to wait between clicking the brush tool and being able to actually brush. This would be a negative user experience.

Therefore one preferred embodiment utilizes an optional multiple-processing-thread method. The M-times-N concept functions also independently from a threaded processing model, however, without this processing model the user would likely experience workflow interruptions caused by processing, making the M-times-N concept a less than optimal experience. As processing power of hardware increases, the need for the optional threaded background processing will decrease. We now describe a suitable background process; as will be evident, other background processing methods can be used.

Background Processing

Processing data in image editing applications may follow various schemes. Currently, there are two typical approaches. On the one hand, in prior art applications image data is always processed at full resolution. Consequently, real-time image editing is impossible. The advantage is that post editing operations (such as printing or saving the image) do not require additional time. On the other hand, applications like Nikon Capture process image data in the resolution, clipping, and size selected by the user. This allows real-time editing for most operations; saving and printing however require additional processing time. The Background Processing now described combines the advantages of both approaches.

In an image processing application image data may come in several versions. Let the input image be denoted by I. First of course, the original, unscaled, unmodified version is kept in memory. We call this version the model; it is denoted by I₀. In a preferred embodiment, I₀=I. On the other hand, several views of this model are available, such as, e.g., the main view of the image and a thumbnail image. Principally, the views are downscaled (or otherwise simplified) versions of the input image. Therefore, they demand less memory than the model. Assume that the number of views is k, the view images will be denoted by I₁ . . . , Iₖ.

The user edits the image, which will be calledfiltering from now on. Naturally he or she wishes to see any filtering results promptly, but this applies only to the views, since they make up the contents of the display. Again, prior art does not offer this feature. The model data comes into play only when transferring the filtered data out of the application, e.g., to a file on disk or to a printer.

Processors in modern desktop computers invariably offer multitasking and multithreading. Therefore, this suggests processing the model data independently in a separate, low-priority thread. The parallel execution of commands presents some challenges, however, as different parallel execution paths must be synchronized. In particular, the image processing requires specific attention to assure correct results.

There are special requirements which add to the complexity. For example, when using a selection tool, the model thread and the view thread do not work in the same way: the brush in the view thread requires the model image (the image at full resolution); the model thread filters only the selected parts. Another special requirement is that, for example, a Resize enhancement also requires access to the model image in order to obtain correct results.

The input image may have an arbitrary number of channels or layers. We assume that it comes in pieces; these pieces are called tiles. The tiles may relate to the image in an arbitrary way, the only restriction is that it must be possible to reconstruct I from all tiles. We set an index r=0, 1, . . , k and pick the corresponding image model or view Iᵣ. Suppose I is divided into n tiles Tᵣₗ, . . . , Trᵣₙ. The division of the image into tiles may vary with the model or view. For example, a thumbnail may require a different tiling than the main view of the image.

Now, let F be the filter applied by the user. The filter F may have a different characteristic for the model and each view. This characteristic of F will be denoted by Fᵣ. The computation of Fᵣ(Iᵣ)=Jᵣ, i. e., the computation of the filtered output image Jᵣ from the input image Iᵣ is calledfiltering part. Due to the special requirement for, e.g., the Resize enhancement (which was explained above), each view filtering part Fᵣ, r=1, . . . , k may access the filtering results of the model filtering part F₀. The union of all filtering parts for r=0, 1, . . ., k is called the filtering process.

Assume that the filter Fᵣ is divided into m enhancements (or sub-filters) Fᵣₗ, . . . , Fᵣₘ such that Fᵣ is the composition:
Fᵣ=Fᵣₘ°Fᵣ₍ₘ₋₁₎° . . . °Fᵣ₂°Fᵣₗ, (1)
where ° denotes composition of maps.

Using this notation, the filtering process can be broken up into processing tasks, (that is, filtering steps), where a single task consists of the application of an enhancement to a tile. Let Tᵣᵢ^{j} denote the filtering result of tile Tᵣᵢ with respect to the first j enhancements (filtering steps) Fᵣⱼ °Fᵣ₍ⱼ₋₁₎° . . . °Fᵣ₁. The filtering process for n tiles and m sub-filters hence consists of nm filtering steps. We assume that a linear ordering of these filtering steps is prescribed. In a preferred embodiment, this ordering is
Tᵣ₁¹, . . . , Tᵣₙ¹, Tᵣ₁², . . . , Tᵣₙ², T₁^{k}, . . . , Tᵣₙ^{k}. (2)

A filtering process is connected to a step pointer, which always points to the last filtering step which has been performed in a sequence, which contains the processing tasks to be executed. The pointer is incremented after computing a filtering step. When the step pointer points to the last filtering step in the ordering, the filtering process is done. Execution of a filtering part is called a thread.

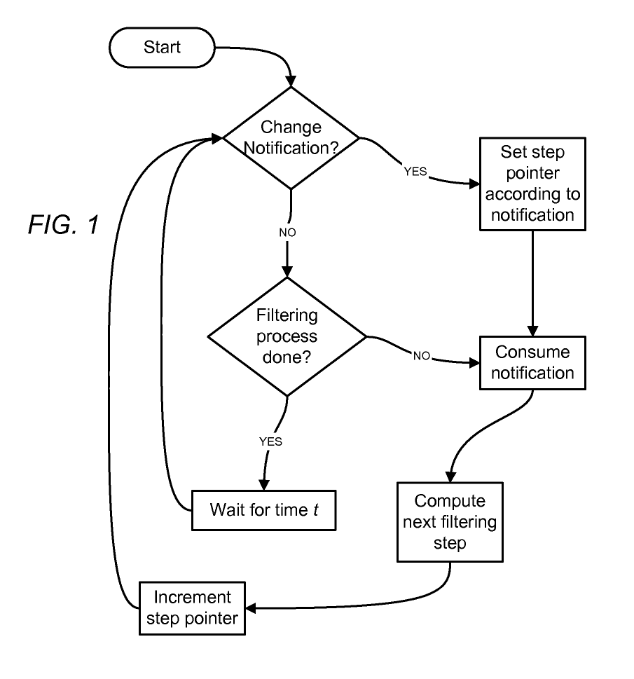

The flowchart of a filtering process in each thread is displayed in FIG. 1. Note that the way of setting the step pointer upon a change notification is not specified, but suitable ways to accomplish this will be known to one of ordinary skill in the art.

A processing task is called trivial, if the filtering output equals the input. It makes sense to have trivial processing tasks: Consider for example the case when an enhancement involves a selection, such as a brush stroke in the model part. Then the effect of that enhancement is confined to a subset of tiles, meaning that the corresponding processing tasks on the complement of that subset are trivial.

The thread which does the filtering of Iᵢ will be denoted by Hᵢ, where l=0, 1, . . . , k. The processing tasks may depend on the thread Hᵣ, r=0, 1, . . . , k. As an example, consider the situation when an image is displayed in a window with scrollbars. Assume that only a small portion (resp. a small number of tiles) is visible. Then it may be possible not to update the remaining tiles. In the words of this document, the processing tasks are trivial. Then, moving the scrollbar counts as a user action which changes the filter.

It is also conceivable to have a tiling which depends on the enhancement. This could mean for example that the number of tiles n varies with the enhancement index j=1, . . . , m.

Each of the threads H₀, H₁, . . . , Hₖ works as illustrated in FIG. 1. Each thread maintains a step pointer; t≧0 is an amount of time.

Since there are several versions of the image, there is the same number of filtering processes. These processes must be coordinated and connected to the user interface. In order to do this, each filtering process runs in a separate thread. As before, I₀ denotes the model and I₁, . . . , Iₖ the views of the input image I. The k views correspond to different places on the screen where the image is displayed, such as the main display window of the image, a thumbnail in a zoom navigation window (called Bird's Eye in Capture NX™), or a thumbnail in the file browser.

By using any means of input, the user creates and modifies the filter F interactively. He may modify the number, type, and parameters of the sub-filters. There is another thread H which processes the user's actions. Each action is analyzed and the threads H₀, H₁, . . . Hₖ are notified accordingly. This is shown in FIG. 3.

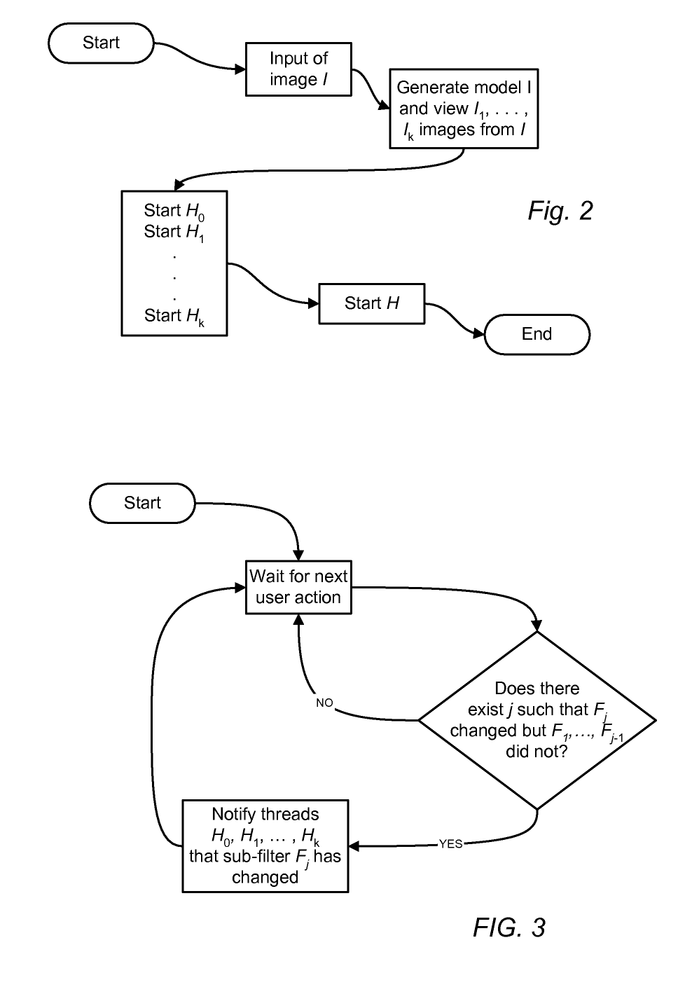

Finally, a top-level program loads the input image and starts the processing threads as shown in FIG. 2.

The change of the parameters of a filter will result in removing the tasks related to that filter as well as the removal of all tasks related to filters following the changed filter in the filter list. After removal new tasks containing all required image tiles in all required resolutions will be added to the sequences. If the last filter in the list was changed, no additional tasks need to be added.

The removal of a filter will result in the removal of all tasks related to that filter from all sequences. Any tasks related to filters following that filter in the list will be added as tasks that need to be processed to the sequence again, or if they do not exist anymore they are newly created. If the last filter in the filter list was removed no tasks need to be added to the sequences. In case a filter is added to the filter list tasks for all necessary resolutions and image tiles are added to the appropriate sequences.

In case a filter is inserted to the filter list new tasks with the new filter and the necessary image tiles in the necessary resolutions are created. All tasks related to filters following the newly introduced filter will be added again as to be processed tasks to the sequences. In case they do not exist anymore those are newly created.

In case the region of interest for any resolution changes tasks containing the effected resolution and tiles are created and added to the sequences.

Sequences can be processed in a single- or multithreaded, multiprocessor, or multi-machine environment.

In an environment like the (m x n multi-purpose tools) concept described herein any enhancement can be applied with a tool. The user interaction in such an environment should be real time. This can be achieved by processing the enhancement first and based on the selection created by a tool blending the enhancement with the image prior to that enhancement. For processing without user interaction better performance can be achieved by processing the enhancement only where the mask described by the tools needs to be processed to reduce overall calculation time.

More than one model. There may be more than one model of the image for whatever reason. In this case there is a separate thread for each model. This would make the models analogous to the views. For instance, it may be faster to keep two models in different formats if the filtering is cheaper than the conversion between these formats.

Alternatives for the notion of a thread. The notion of the thread was chosen for H and H₁, . . . , Hₖ. The notion of a thread may be replaced by anything suitable, in particular by the one of a process, a CPU, or a computer.

Unification of threads. Any subset of the threads H₁, . . . , Hₖ may be unified with the main thread H. In this case, parallelism is lost for these parts, but this may be desired if the threads in the subset work on small amounts of image data as, e.g., a thumbnail. The same applies to the models, in case there is more than model.

Different thread communication. The communication by means of a sequence may be different, or the thread communication by means of the smallest index of changed sub-filters (cf. FIG. 3) may be different.

Application to non-image data. The described setup can also be applied to other than image data, such as, e.g., video or audio data. For example, take the case of audio data. In an interactive audio editing application the model could be a high-quality .wav file which takes long to process. Editing of the filters could be presented to the user as repeated playback of the modified down sampled or compressed version of the high-quality file. The processing of the high-quality model version would happen in a background thread.

Use of threads in an image editing application will dramatically increase perceived speed. This not only allows for better response times, but it makes it also possible to create new user interaction models regarding the usage of tools like brushes, selections or gradients. User Interface

FIG. 5 demonstrates a suitable user interface for the M-times-N multi-purpose tool. The image window 500 of an image editing application is depicted. The user has currently defined area 501 as the area to receive the current enhancement. For instance, the user could use a plus brush 505 to apply a blurring effect onto area 501. The cursor (mouse pointer) that the user uses while applying a plus or minus tool is shown with icon 502.

The image portion 503 displayed in window 500 typically shows less pixels to the user than are contained in the actual image file. This can be sub-sampled data (for instance, only every other pixel if the image is viewed at 50%), or only a cropped part of the image (for instance only top left corner), or both. Note that 503 denotes a preview size of the image, being processed by a thread H₁ with l not zero.

A dialog box 504 represents the state of the current enhancement (also referred to as the settings of a sub-filter Fⱼ in this disclosure). A button icon 505 representing a plus tool, and a button icon 506 representing a minus tool are also displayed.

Variations of the Invention

The following additional embodiments and options are available:

Plus and Minus: The Invention can work with plus and minus tools, but the plus and minus concept is not required for the invention to be effective.

Switch Enhancements: The user can exchange an enhancement “on the fly” with another enhancement, while the current “selection”, created by any number of tools, is maintained. For instance, the application can provide a graphical region that allows the user to see what enhancement is currently selected, but that graphical region can also be used to switch from the current enhancement to an additional enhancement. If the user switches the current enhancement, he will see directly that the image is now affected by a different effect in exactly those areas that were masked using plus and minus tools.

Combining Tools with one enhancement: The user can use any number of tools in order to refine the effect of one enhancement. Simultaneously, he can make adjustments to the enhancement currently applied. For instance, he can use a blur filter for softening, and he can use plus and minus gradients and plus and minus brushes to consistently refine the area, and while doing this, changes to the blur radius are possible at any time.

Arbitrary Sequence: One key benefit of this workflow is that the user is not forced to decide in a certain sequence. He can commence a step by selecting an appropriate tool, or he can start by selecting an appropriate enhancement. (Unlike some current commercial programs, where if applying a blur selectively, the user must first create a layer with a mask, then apply a blur in the correct strength, then use selectivity tools—other sequences aren't easily possible).

Complexity: If M tools and N enhancements are provided, the user can use about (M*2^{N}) different effects—while the complexity of the UI is only (M+N). For 5 tools and 5 enhancements, this means that the UI needs only 10 base elements, while roughly 160 different effects are supported.

Fill by Default: This invention can be implemented so that when the user selects an enhancement, the tool “fill entire image” is performed automatically and possibly it's button is highlighted. This ensures that enhancements are applied globally in the case that the user hasn't used any selective tools.

Streamlined Behavior: Streamlined default settings: if for instance after a click on the plus brush the colorize tool is opened by default, the standard behavior of the brush is to simply brush a color into the image. This way the expectation of the user not used to M-times-N is met to a high degree.

Trial-and-Error friendly: If the user does not exactly know how to achieve an effect, he can for instance start with a brush stroke over the desired area, and then keep exchanging the enhancement until he likes the effect, without a need to redo the brush stroke.

Changes to enhancement at any time: The user can make adjustments to the enhancement (such as the radius used for blurring) before, after, or between the brush strokes, without a need to open an interface. While working with the brush, the user can leave the enhancement window open at all time.

Linking Enhancements: The user can link any enhancement with another one—for instance by holding down the shift key when selecting a second enhancement while a first enhancement is active. These two enhancements can then both be applied to the image with the tools. Of course, as opposed to adding linked enhancements, these can of course also be deleted or exchanged with other tools, or their sequence can be changed.

Auto-Clearing: If at a certain stage the user is applying an enhancement to the full image and then selects the minus brush, the effect is reduced at the location of the brush stroke. Simultaneously, when in the same situation the plus brush is used, the effect can be cleared off the image (clearing the mask) so that the effect is then only applied where the plus brush stroke was performed.

Default filling: If the user clicks on a tool while no step is active, the default enhancement for this tool can open. If the user clicks on a plus tool, the effect should only be visible where the user applies the tool (and not visible before the user applies the plus tool). However, if the user chooses a minus tool, the effect could be applied to the full image and then be “taken out” where the user uses the minus tool. So, for instance, if the user clicks on the minus brush, brushes over the eyes in a portrait, and then (if not already the case) toggles the current enhancement to a blur effect. This workflow should apply the blur to the full image except the eyes. This feature may not make sense with specific tools, such as the fill entire image and clear entire image tool.

Default Sets: Since some users may not know how to achieve certain effects, the application can offer certain shortcuts. Such a shortcut could for instance be called “dodge” and, if executed, the application would activate a certain plus brush with a tool suitable to create a dodge effect (such as Curves) with preset parameters (such as a curve bent upwards). That is, for all needs that the user has, the application can offer recorded combinations of tools and effects.

Global to selective w/o creating a mask: With current image editing applications, if the user has applied an effect globally and then decides to take out the intensity of the effect at a certain location, he first needs to create a mask with respect to a layer. Using this invention, the user can use any tool directly on the effect being applied globally.

Change brushed effect after brushing: If a user of the application Photoshop wants to draw a color (for instance brown) in a certain mode (for inane overlay) into an image area (for instance the hair of a person), he needs to guess the correct color and opacity, then perform the brush stroke, and if something does not match, he has to undo and start over with a new color. In our invention the user can draw a brush stroke onto the area of interest and then tweak the color (respectively the enhancement settings). These changes to the color will then affect the brush stroke(s) that are already drawn. In our invention, when the user wants to accept the current color and brush strokes and start painting with a new color, he has to “close” the current step and start a new one.

Advantageously, the invention may be embodied on a computer readable medium having contents for causing a computer-based information handling system to perform the steps described herein, and packaged together with a pointing device, such as a mouse or pen tool, to be marketed as a kit.

This invention is not limited to particular hardware described herein, and any hardware presently existing or developed in the future that permits processing of digital images using the method disclosed can be used.

The term memory block or data block refers to any possible computer-related image storage structure known to those skilled in the art, including but not limited to RAM, processor cache, hard drive, or combinations of those, including dynamic memory structures. Preferably, the methods disclosed will be embodied in a computer program (not shown) either by coding in a high level language, or by preparing a plug-in application which is complied and available as an adjunct to an image processing program. The multi-purpose editing tool described herein is useable as a plug-in supplemental program, as an independent module that may be integrated into any commercially available image processing program, or into any image processing device that is capable of modifying and displaying an image, such as a color copier or a self service photo print kiosk, as a dynamic library file or similar module that may be implemented into other software programs whereby image measurement and modification may be useful, or as a stand alone software program.

Any currently existing or future developed computer readable medium suitable for storing data can be used to store the programs embodying the afore-described interface, methods and algorithms, including, but not limited to hard drives, floppy disks, digital tape, flash cards, compact discs, and DVDs. The computer readable medium can comprise more than one device, such as two linked hard drives. This invention is not limited to the particular hardware used herein, and any hardware presently existing or developed in the future that permits image processing can be used.

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising”, “comprises” and “comprised” are not intended to exclude other additives, components, integers or steps.

Also, it is noted that the embodiments are disclosed as a process that is depicted as a flowchart, a flow diagram, a structure diagram, or a block diagram. Although a flowchart may disclose various steps of the operations as a sequential process, many of the operations can be performed in parallel or concurrently. The steps shown are not intended to be limiting nor are they intended to indicate that each step depicted is essential to the method, but instead are exemplary steps only.

The term “storage medium” can represent one or more devices for storing data, including read-only memory (ROM), random access memory (RAM), magnetic disk storage mediums, optical storage mediums, flash memory devices, electrical storage mediums or other mediums for storing information in a form readable by a machine such as, for example, a computer. The term “data element” refers to any quantum of data packaged as a single item. The term “data unit” refers to a collection of data elements or data units that comprise a logical section. The term “image block” refers to a complete copy or partial copy of a digital image that is stored in a separate storage location and can be altered without affecting the original stored digital image.

In the foregoing specification, the invention has been described with reference to specific embodiments thereof. It will, however, be evident that various modifications and changes may be made thereto without departing from the broader spirit and scope of the invention. The specification and drawing are, accordingly, to be regarded in an illustrative rather than a restrictive sense. It should be appreciated that the present invention should not be construed as limited by such embodiments.

What is claimed:

1. A method for applying enhancements to a digital image, comprising the steps of:
receiving the image at a first resolution;
displaying a preview of the image to a user;
allowing the user to select a first area in the preview;
allowing the user to assign a first enhancement to the user-selected area;
filtering a subset of pixels of the image at the first resolution;
blending the filtered subset into the image using a mask derived from the user-selected area;
displaying a preview of the image with a blended-in enhanced area; and
providing the user with options to select a second area in the preview, or assign a second enhancement, and repeating the filtering, blending and displaying steps if any option is exercised.

2. The method of claim 1, where the preview is at a second resolution.

3. The method of claim 1, where the subset of pixels is a sub-sampling of the image.

4. The method of claim 1, where the subset of pixels contains those pixels in the neighborhood of the user-selected area.

5. The method of claim 1, further comprising the steps of using a first processing thread to process the subset of pixels, and using a second processing thread to process additional pixels of the image.

6. The method of claim 1, further comprising the step of voiding the first enhancement when a second enhancement is assigned.

7. The method of claim 1, further comprising the step of voiding the first area selection when a second area is selected.

8. The method of claim 1, the providing step further comprising the option to expand, modify or shrink a user-selected area.

9. A method for applying enhancements to a digital image, comprising the steps of:
receiving the image at a first resolution;
recording a series of first enhancements to the image received from the user, into an edit list;
using a first processing thread to display a preview of the result of the enhancement series,
processing a subset of the pixels in the image;
recording a series of second, or modified first, enhancements to the image received from the user, into the edit list;
reprocessing the subset of the pixels with the second, or modified first, enhancements; and
processing the image at a final resolution using the full edit list.

10. A method for enhancing images based on a multi-threading system, enabling a user to enhance an image in a trial-and-error workflow, comprising the steps of:
allowing the user to define a series of enhancements;
allowing the user to assign regions of interest to one or more of said enhancements;
providing a preview to the user based on a subset of pixels processed by a first processing thread;
using, in parallel to the first thread, a second thread for processing a larger amount of pixels;
allowing the user to make a decision based on said preview whether or not to retain the current set of enhancements and regions-of-interest; and
allowing the user, based on said decision, to do one or more of the following trial-and-error modifications:
a) remove one or more enhancements from the list;
b) change the enhancements associated with a certain region-of-interest;
c) modify one or more of the regions of interest;
d) remove enhancements from said series of enhancements which no longer contribute to the result after the user has performed said trial-and-error modifications resulting in a simplification of said enhancements; and
e) ensuring that any simplification of the series of enhancements is communicated to the second processing thread.

11. A computer readable medium having contents for causing a computer-based information handling system to perform the steps of the method of claim 1.

12. A computer readable medium having contents for causing a computer-based information handling system to perform the steps of the method of claim 9.

13. A computer readable medium having contents for causing a computer-based information handling system to perform the steps of the method of claim 1O.
